(19) United States
(12) Patent Application Publication
(10) Pub. No.: US 2025/0157402 A1
(43) Pub. Date: May 15, 2025

(54) DISPLAY APPARATUS AND METHOD OF COMPENSATING DETERIORATION OF DISPLAY PANEL USING THE SAME

(71) Applicant: SAMSUNG DISPLAY CO., LTD., YONGIN-SI (KR)

(72) Inventors: MIN-SEOK BAE, Yongin-si (KR); KANGHEE LEE, Yongin-si (KR)

(21) Appl. No.: 18/928,365

(22) Filed: Oct. 28, 2024

(30) Foreign Application Priority Data
Nov. 9, 2023 (KR) 10-2023-0154331

(51) Int. Cl. G09G 3/3233

(52) U.S. Cl. CPC G09G 3/3233; G09G 2300/0819; G09G 2300/0852; G09G 2300/0861; G09G 2320/0233; G09G 2320/0242; G09G 2320/045; G09G 2320/0686

(57) ABSTRACT

A display apparatus includes a display panel, a driving controller and a data driver. The display panel includes a low deterioration region and a high deterioration region. The driving controller generates a data signal based on input image data. The data driver converts the data signal to a data voltage and outputs the data voltage to the display panel. The driving controller includes a deterioration compensator which generates the data signal based on a deterioration ratio. The deterioration ratios may be a ratio between a sensing current of the low deterioration region and a sensing current of the high deterioration region.

### CROSS-REFERENCE TO RELATED APPLICATION

This application claims priority under 35 USC § 119 to Korean Patent Application No. 10-2023-0154331, filed on Nov. 9, 2023, in the Korean Intellectual Property Office KIPO, the contents of which are herein incorporated by reference in its entirety.

### BACKGROUND

### 1. Field

One or more embodiments of the present inventive concept relate to a display apparatus and a method of compensating a deterioration of a display panel included in the display apparatus.

### 2. Description of the Related Art

A display apparatus includes a display panel and a display panel driver. The display panel may include a plurality of gate lines, a plurality of data lines, a plurality of sensing lines, and a plurality of pixels. The display panel driver may include a gate driver which provides a gate signal to the gate lines and a data driver which provides data voltages to the data lines. In some cases, the display panel driver may include a sensing driver which performs a sensing operation of driving characteristics of the pixels. The display panel driver may include a driving controller which controls the gate driver, the data driver and the sensing driver.

Over time, the display panel may experience deterioration. For example, a sensing current corresponding to a black color (or grayscale value) may change depending on deterioration time. However, this change in sensing current corresponding to the black color may not be taken into consideration when performing a non-emitting sensing operation. As a result, the accuracy of a deterioration compensation operation may be reduced due to deterioration compensation error.

### SUMMARY

One or more embodiments of the present inventive concept provide a display apparatus that compensates for deterioration of the display panel.

One or more embodiments may perform compensation by reflecting a change in sensing current corresponding to a black color when performing non-emitting sensing of the display panel. This may improve the display quality of the display panel by improving the accuracy of deterioration compensation.

Embodiments of the present inventive concept also provide a method of compensating a deterioration of a display panel using the display apparatus.

In an embodiment of a display apparatus according to the present inventive concept, a display apparatus includes a display panel, a driving controller and a data driver. The display panel includes a low deterioration region and a high deterioration region. The driving controller generates a data signal based on input image data. The data driver converts the data signal to a data voltage and outputs the data voltage to the display panel. The driving controller includes a deterioration compensator. The deterioration compensator generates the data signal based on a deterioration ratio which is a ratio between a sensing current of one or more pixels in the low deterioration region and a sensing current of one or more pixels in the high deterioration region.

In an embodiment of the present inventive concept, the driving controller may further include a stress convertor outputting a luminance reduction rate of a pixel according to a deterioration time to the deterioration compensator. The low deterioration region may be a region where the luminance reduction rate is at a first level, e.g., a minimum. The high deterioration region may be a region where the luminance reduction rate is at a second level, e.g., a maximum.

In an embodiment of the present inventive concept, the deterioration compensator may output the data signal based on the luminance reduction rate corresponding to the deterioration ratio.

In an embodiment of the present inventive concept, the driving controller may further include a nonvolatile memory configured to store the luminance reduction rate of the pixel according to the deterioration time.

In an embodiment of the present inventive concept, the driving controller may store the deterioration ratio and the luminance reduction rate corresponding to the deterioration ratio.

In an embodiment of the present inventive concept, the deterioration compensator may generate a prediction function based on the stored deterioration ratio and the stored luminance reduction rate corresponding to the deterioration ratio.

In an embodiment of the present inventive concept, the prediction function may be a linear function.

In an embodiment of the present inventive concept, the low deterioration region and the high deterioration region may change according to the deterioration time.

In an embodiment of the present inventive concept, the deterioration ratio may be a ratio between a value obtained by dividing the sensing current of the one or more pixels in the high deterioration region after a deterioration time by the sensing current of the one or more pixels in the low deterioration region after the deterioration time and a value obtained by dividing the sensing current of the one or more pixels in the high deterioration region in an initial time by the sensing current of the one or more pixels in the low deterioration region in the initial time.

In an embodiment of the present inventive concept, the display apparatus further include a sensing driver. The high deterioration region may include one or more high deterioration red pixels, one or more high deterioration green pixels, and one or more high deterioration blue pixels. The low deterioration region may include one or more low deterioration red pixels, one or more low deterioration green pixels, and one or more low deterioration blue pixels. The sensing driver may perform a sensing operation receiving the sensing current of the one or more in the low deterioration region and the sensing current of the one or more in the high deterioration region. The sensing operation may be performed for the one or more high deterioration red pixels, the one or more high deterioration green pixels, the one or more high deterioration blue pixels, the one or more low deterioration red pixels, the one or more low deterioration green pixels and the one or more low deterioration blue pixels.

In an embodiment of the present inventive concept, the deterioration ratio may include a red deterioration ratio which is a ratio between the sensing current of the one or more high deterioration red pixels and the sensing current of the one or more low deterioration red pixels, a green deterioration ratio which is a ratio between the sensing current of the one or more high deterioration green pixels and the sensing current of the one or more low deterioration green pixels and a blue deterioration ratio which is a ratio between the sensing current of the one or more high deterioration blue pixels and the sensing current of the one or more low deterioration blue pixels.

In an embodiment of the present inventive concept, the driving controller may further include a stress converter configured to output a luminance reduction rate of a pixel according to a deterioration time to the deterioration compensator. The driving controller may store the red deterioration ratio and the luminance reduction rate corresponding to the red deterioration ratio and may generate a red prediction function based on the red deterioration ratio and the luminance reduction rate corresponding to the red deterioration ratio. The driving controller may store the green deterioration ratio and the luminance reduction rate corresponding to the green deterioration ratio and may generate a green prediction function based on the green deterioration ratio and the luminance reduction rate corresponding to the green deterioration ratio. The driving controller may store the blue deterioration ratio and the luminance reduction rate corresponding to the blue deterioration ratio and may generate a blue prediction function based on the blue deterioration ratio and the luminance reduction rate corresponding to the blue deterioration ratio. The driving controller may generate the data signal based on the red prediction function, the green prediction function and the blue prediction function.

In an embodiment of the present inventive concept, the sensing operation may be performed in response to a power-on signal.

In an embodiment of the present inventive concept, display apparatus may further include a sensing driver. The sensing driver may perform a sensing operation receiving the sensing current of the one or more in the low deterioration region and the sensing current of the one or more in the high deterioration region. The data driver may apply the data voltage corresponding to white color to the high deterioration region and the low deterioration region. The driving controller, based on the sensing current corresponding to the white color of the high deterioration region and the sensing current corresponding to the white color of the low deterioration region, may calculate a red deterioration ratio which is a ratio between the sensing current of one or more high deterioration red pixels and the sensing current of one or more low deterioration red pixels, a green deterioration ratio which is a ratio between the sensing current of one or more high deterioration green pixels and the sensing current of one or more low deterioration green pixels and a blue deterioration ratio which is a ratio between the sensing current of one or more high deterioration blue pixels and the sensing current of one or more low deterioration blue pixels.

In an embodiment of the present inventive concept, the driving controller may further include a stress converter configured to output the luminance reduction rate of the pixel according to the deterioration time to the deterioration compensator. The driving controller may store the red deterioration ratio and the luminance reduction rate corresponding to the red deterioration ratio and may generate a red prediction function based on the red deterioration ratio and the luminance reduction rate corresponding to the red deterioration ratio. The driving controller may store the green deterioration ratio and the luminance reduction rate corresponding to the green deterioration ratio and may generate a green prediction function based on the green deterioration ratio and the luminance reduction rate corresponding to the green deterioration ratio. The driving controller may store the blue deterioration ratio and the luminance reduction rate corresponding to the blue deterioration ratio and may generate a blue prediction function based on the blue deterioration ratio and the luminance reduction rate corresponding to the blue deterioration ratio. The driving controller may generate the data signal based on the red prediction function, the green prediction function and the blue prediction function.

In an embodiment of the present inventive concept, the low deterioration region and the high deterioration region may include a pixel. The pixel may include a driving transistor configured to output a driving current, a light emitting element configured to emit a light based on the driving current, an initialization transistor configured to apply an initialization voltage to a second electrode of the driving transistor, a scan transistor configured to apply the data voltage to a control electrode of the driving transistor, a compensation transistor configured to apply a reference voltage to the control electrode of the driving transistor, an emission control transistor configured to control a generation of the driving current, a first capacitor including a first electrode connected to the control electrode of the driving transistor and a second electrode connected to the second electrode of the driving transistor and a second capacitor including a first electrode receiving a first power voltage and a second electrode connected to the second electrode of the driving transistor.

In an embodiment of compensating deterioration of display panel according to the present inventive concept, the method includes storing a luminance reduction rate of pixel according to a deterioration time, calculating a deterioration ratio which is a ratio between a sensing current of one or more pixels in the high deterioration region where the luminance reduction rate is at a first level (e.g., a maximum) and a sensing current of one or more pixels in the low deterioration region where the luminance reduction rate is at a second level lower than the first level (e.g., a minimum), storing the deterioration ratio and the luminance reduction rate corresponding to the deterioration ratio and generating a data signal based on the luminance reduction rate.

In an embodiment of the present inventive concept, the method may further include generating a prediction function based on the stored deterioration ratio and the stored luminance reduction rate corresponding to the deterioration ratio after storing the luminance reduction rate corresponding to the deterioration ratio. The data signal may be generated based on the prediction function.

In an embodiment of the present inventive concept, the low deterioration region and the high deterioration region may change according to the deterioration time.

In an embodiment of the present inventive concept, the deterioration ratio may be a ratio between a value obtained by dividing the sensing current of the one or more pixels in the high deterioration region after a deterioration time by the sensing current of the one or more pixels in the low deterioration region after the deterioration time and a value obtained by dividing the sensing current of the one or more pixels in the high deterioration region in an initial time by the sensing current of the one or more pixels in the low deterioration region in the initial time.

In accordance with one or more embodiments, a method for compensating a display apparatus includes receiving a first sensing current of a pixel in a high deterioration region of a display panel; receiving a second sensing current of a pixel in a low deterioration region of the display panel; calculating a deterioration ratio based on the first sensing current and the second sensing current; determining a luminance reduction rate which corresponds to the deterioration ratio; generating a prediction function based on the deterioration ratio and the luminance reduction rate; and generating a data signal based on the prediction function.

The pixel in the high deterioration region may be configured to emit light of a first level, and the pixel in the low deterioration region may be configured to emit light of a second level less than the first level. The low deterioration region and the high deterioration region change over time.

According to the display apparatus described above and the method of compensating a deterioration of a display panel using the display apparatus, by compensating a deterioration of the display panel using the deterioration ratio between the high deterioration region and a low deterioration region of the display panel, so that a deterioration compensation error may be reduced. Additionally, the prediction function based on the deterioration ratio and the luminance reduction rate corresponding to the deterioration ratio.

Accordingly, an accuracy of the deterioration compensation may be improved and the display quality of the display apparatus may be improved.

### BRIEF DESCRIPTION OF THE DRAWINGS

The above and other features and advantages of the present inventive concept will become more apparent by describing in detailed embodiments thereof with reference to the accompanying drawings, in which:

FIG. 1 is a block diagram illustrating a display apparatus according to an embodiment of the present inventive concept;

FIG. 2 is a circuit diagram illustrating a pixel and a sensing driver of FIG. 1 according to an embodiment;

FIG. 3 is a block diagram illustrating a driving controller of FIG. 1 according to an embodiment;

FIG. 4 is a graph illustrating a luminance reduction rate according to a deterioration time stored in a driving controller of FIG. 1 according to an embodiment;

FIG. 5 is a graph illustrating a prediction function in which a driving controller of FIG. 1 generates according to an embodiment;

FIG. 6 is a diagram illustrating a high deterioration region and a low deterioration region of display panel of FIG. 1 in a first time according to an embodiment;

FIG. 7 is a diagram illustrating a high deterioration region and a low deterioration region of display panel of FIG. 1 in a second time according to an embodiment;

FIG. 8 is a flowchart illustrating an operation of a driving controller and a sensing driver of FIG. 1 according to an embodiment;

FIG. 9 is a flowchart illustrating an operation of a driving controller and a sensing driver of FIG. 1 according to an embodiment;

FIG. 10 is a block diagram illustrating an electronic apparatus according to an embodiment of the present inventive concept; and

FIG. 11 is a block diagram illustrating an example of an electronic apparatus of FIG. 10.

### DETAILED DESCRIPTION OF THE EMBODIMENTS

Hereinafter, the present inventive concept will be described in more detail with reference to the accompanying drawings.

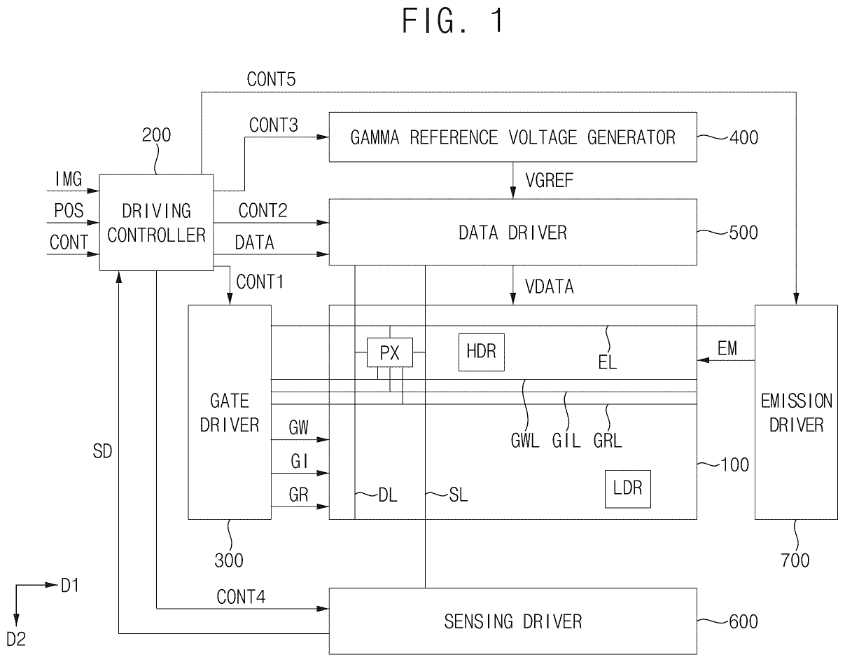

FIG. 1 is a block diagram illustrating a display apparatus according to an embodiment of the present inventive concept.

Referring to FIG. 1, the display apparatus according to embodiments of the present inventive concept may include a display panel 100 including a plurality of pixels PX and a panel driver for driving the display panel 100. In an embodiment, the panel driver may include a gate driver 300, a data driver 500, a sensing driver 600, and an emission driver 700. The gate driver 300 provides one or more gate signals to corresponding gate lines. In one embodiment, the gate driver 300 provides a first gate signal GW, a second gate signal GR and a third gate signal GI to the pixels PX. The data driver 500 is connected to the pixels PX through data lines DL. The sensing driver 600 is connected to the pixels PX through sensing lines SL for helping to perform a deterioration compensation operation. The emission driver 700 is connected to the pixels PX through emission lines EL. The display apparatus may also include a driving controller 200 which controls the gate driver 300, the data driver 500, the sensing driver 600 and the emission driver 700.

The display panel 100 may include the data lines DL and the pixels PX connected to the data lines DL. Additionally, the display panel 100 may include a plurality of gates lines (e.g., gate lines GWL, GRL and GIL) for respectively providing the first gate signal GW, the second gate signal GR and the third gate signal GI to the pixels PX. For example, the display panel 100 may be, for example, an organic light emitting diode (OLED) display panel or a quantum dot (QD) display panel, but the present inventive concept is not limited thereto.

In the present embodiment, the display panel 100 may include at least one high deterioration region HDR and at least one low deterioration region LDR. Each of the at least one high deterioration region HDR and that at least one low deterioration region LDR may include one or more pixels. In the present embodiment, the high deterioration region HDR may refer to as a region where the luminance reduction rate is at a first level, which, for example, may be an elevated or a maximum rate. Additionally, in the present embodiment, the low deterioration region LDR may refer to as a region where the luminance reduction rate is at a second level less than the first level. The second level may be a reduced or minimum rate. For example, the high deterioration region HDR may be a region where one or more pixels emit light having an accumulated grayscale value that is at a maximum. For example, the low deterioration region LDR may be a region where one or more pixels emit light having an accumulated grayscale value that is at a minimum.

The display apparatus may include the display panel 100, the driving controller 200, the gate driver 300, the data driver 500, the sensing driver 600 and an emission driver 700. In an embodiment, the driving controller 200 and the data driver 500 may be formed integrally with each other, for example, in a same chip.

The display panel 100 includes a display region configured to display an image and a peripheral region adjacent to the display region. In an embodiment, the gate driver 300 may be disposed in the peripheral region. In an embodiment, the gate driver 300 may be integrated in the peripheral region.

The display panel 100 may include the gate lines GWL, GRL and GIL, the data lines DL, the emission lines EL, and pixels PX which are electrically connected to the gate lines GWL, GRL and GIL, the data lines DL, the emission lines EL. The gate lines GWL, GRL and GIL may extend in a direction that intersects the direction in which the data lines DL extend.

The driving controller 200 receives input image data IMG, an input control signal CONT, and a power-on signal POS from a host processor (e.g. application processor) and/or graphic processing unit (GPU). For example, the input image data IMG may include red image data, green image data and blue image data corresponding to an image to be displayed. In one embodiment, the input image data IMG may include white image data. In one embodiment, the input image data IMG may include magenta image data, yellow image data and cyan image data. The input control signal CONT may include a plurality of signals. For example, the input control signal CONT may include a master clock signal and a data enable signal. In one embodiment, the input control signal CONT may further include a vertical synchronization signal and a horizontal synchronization signal.

The driving controller 200 may generate a plurality of control signals. For example, the driving controller 200 may generate a first control signal CONT1, a second control signal CONT2, a third control signal CONT3, a fourth control signal CONT4, and a fifth control signal CONT5. The driving controller may also generate a data signal DATA, which may be based on the input image data IMG and the input control signal CONT.

The driving controller 200 may generate the first control signal CONT1 for controlling operation of the gate driver 300 based on the input control signal CONT, and may output the generated first control signal CONT1 to the gate driver 300. The first control signal CONT1 may include, for example, a vertical start signal and a gate clock signal.

The driving controller 200 may generate the third control signal CONT3 for controlling an operation of gamma reference voltage generator 400 based on the input control signal CONT, and may output the generated third control signal CONT3 to the gamma reference voltage generator 400.

The driving controller 200 may generate the second control signal CONT2 for controlling operation of the data driver 500 based on the input control signal CONT, and may output the generated second control signal CONT2 to the data driver 500. The second control signal CONT2 may include, for example, a horizontal start signal and a load signal.

The driving controller 200 may generate the data signal DATA based on the input image data IMG. The driving controller 200 may output the data signal DATA to the data driver 500.

The driving controller 200 may generate the third control signal CONT4 based on the power-on signal POS and the input control signal CONT. The driving controller 200 may output the fourth control signal CONT4 to the sensing driver 600.

The driving controller 200 may generate the fifth control signal CONT5 for controlling operation of the emission driver 700 based on the input control signal CONT, and may output the generated fifth control signal CONT5 to the emission driver 700.

The gate driver 300 may generate the gate signals GW, GR and GI for driving the gate lines GWL, GRL and GIL in response to the first control signal CONT1 received from the driving controller 200. The gate driver 300 may output the gate signals GW, GR and GI to respective ones of the gate lines GWL, GRL and GIL.

The gamma reference voltage generator 400 generates a gamma reference voltage VGREF in response to the third control signal CONT3 received from the driving controller 200. The gamma reference voltage generator 400 provides the gamma reference voltage VGREF to the data driver 500. The gamma reference voltage VGREF has a value corresponding to each data signal DATA. For example, the gamma reference voltage generator 400 may be disposed in the driving controller 200 or in the data driver 500.

The data driver 500 receives the second control signal CONT2 and the data signal DATA from the driving controller 200 and receives the gamma reference voltage VGREF from the gamma reference voltage generator 400. The data driver 500 converts the data signal DATA into a data voltage VDATA in analog form using the gamma reference voltage VGREF. The data driver 500 outputs the data voltage VDATA to a pixel through a corresponding one of the data lines DL.

In an embodiment, the data driver 500 may be implemented with one or more integrated circuits. In another embodiment, the data driver 500 and the driving controller 200 may be implemented as a single integrated circuit and, for example, the single integrated circuit may be called a timing controller embedded data driver (TED).

The sensing driver 600 may be used to assist in the performance of a deterioration compensation operation. The sensing driver 600 may receive the fourth control signal CONT4 from the driving controller 200 and may generate sensing data SD by sensing characteristic data of the pixels PX through the sensing lines SL. For example, the sensing driver 600 may sense a driving characteristic (e.g., a mobility and/or a threshold voltage) of the driving transistor by measuring a sensing current (or a sensing voltage) of the driving transistor of a pixel PX through the sensing line SL. For example, an operation of sensing the driving characteristic (e.g., a mobility and/or a threshold voltage) of the driving transistor may be called a sensing operation.

In the present embodiment, the sensing driver 600 may output the sensing data SD of the high deterioration region HDR and the sensing data SD of the low deterioration region LDR to the driving controller 200. In an embodiment, the sensing driver 600 may be implemented with a separate integrated circuit from an integrated circuit of the data driver 500. In other embodiments, the sensing driver 700 may be included in the data driver 500 or may be included in the driving controller 200.

The emission driver 700 may generate the emission signal EM for driving the emission lines EL in response to the fifth control signal CONT5 received from the driving controller 200. The emission driver 700 may output the emission signal EM to the emission lines EL. In an embodiment of the present inventive concept, the emission driver 700 may be integrated on the peripheral region of the display panel 100. In an embodiment of the present inventive concept, the emission driver 700 may be mounted on the peripheral region of the display panel 100.

Although the gate driver 300 is disposed on a first side of the display panel 100, and the emission driver 700 is disposed on a second side of the display panel 100 in FIG. 1 for convenience of explanation, the present inventive concept is not limited thereto. The gate driver 300 and the emission driver 700 may be disposed on the same (e.g., first) side of the display panel 100. For example, the gate driver 300 and the emission driver 700 may be disposed on the peripheral region of the display panel 100 on the same side of the display region of the display panel 100. For example, the gate driver 300 and the emission driver 700 may be formed integrally with each other.

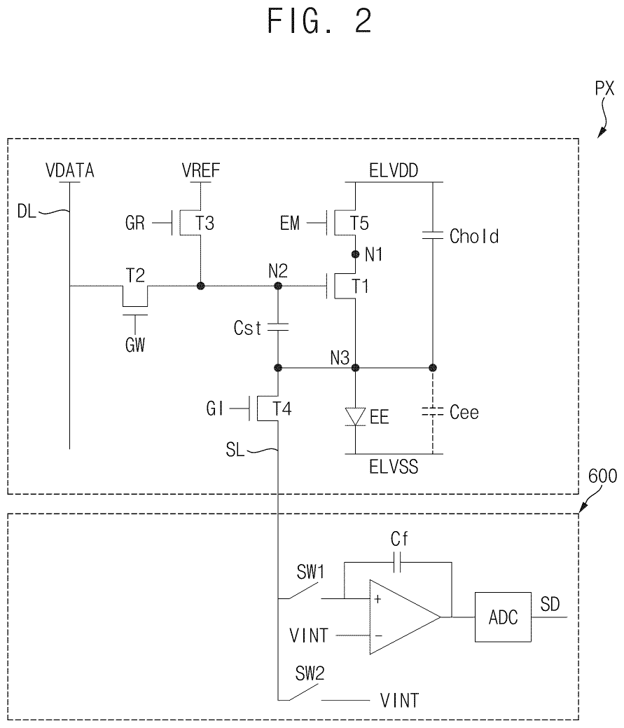

FIG. 2 is a circuit diagram illustrating a pixel PX and a portion of the sensing driver 600 of FIG. 1.

Referring to FIG. 1 and FIG. 2, each of the pixels PX may include a driving transistor T1, a scan transistor T2, a compensation transistor T3, an initialization transistor T4, an emission control transistor T5, a first capacitor CST, a second capacitor CHOLD and a light emitting element EE. In an embodiment, the pixel PX may further include a parasitic capacitor CEE. The pixels PX may have a different number of transistors and capacitors in another embodiment.

The driving transistor T1 may include a first electrode connected to a first node N1, a control electrode connected to a second node N2 and a second electrode connected to a third node N3. The driving transistor T1 may output a driving current based on a voltage of the second node N2. Characteristic data of the driving transistor T1 may be output as sensing data to the driving controller from the sensing driver, in order to perform deterioration compensation of the display panel.

The scan transistor T2 may include a first electrode connected to the data line DL, a control electrode receiving the first gate signal GW and a second electrode connected to the second node N2. When the scan transistor T2 is turned-on in response to the first gate signal GW, the data voltage VDATA may be applied to the gate electrode (e.g., the second node N2) of the driving transistor T1.

The compensation transistor T3 may include a first electrode receiving a reference voltage VREF, a control electrode receiving the second gate signal GR, and a second electrode connected to the control electrode (e.g., the second node N2) of the driving transistor T1. When the compensation transistor T3 is turned-on in response to the second gate signal GR, the reference voltage VREF may be applied to the control electrode (e.g., the second node N2) of the driving transistor T1.

The initialization transistor T4 may include a first electrode connected to the second electrode (e.g., the third node N3) of the driving transistor T1, a control electrode receiving the third gate signal GI and a second electrode connected to the sensing line SL and receiving an initialization voltage VINT. When the initialization transistor T4 is turned-on in response to the third gate signal GI, the initialization voltage VINT may be applied to the second electrode (e.g., the third node N3) of the driving transistor T1.

The initialization transistor T4 may be connected to the sensing driver 600 through the sensing line SL. The initialization transistor T4 may apply the initialization voltage VINT to the second electrode (e.g., the third node N3) of the driving transistor T1. As well, the driving current of driving transistor T1 may flow to the sensing driver 600 through the initialization transistor T4 and the sensing line SL. In the present embodiment, the driving current may flow to the sensing line SL and may be called as a sensing current indicative of a driving characteristic of the driving transistor T1. In the present embodiment, the sensing driver 600 may generate the sensing data SD.

In an embodiment, the sensing driver 600 may include an integrator and an analog-digital converter ADC. The integrator (e.g., an operational amplifier) may be connected to one or more of the pixels PX through the sensing line SL, may be receive the sensing current of the driving transistor T1 of a pixel PX through the sensing line SL, and may generate an outputting voltage. A first (inverting) input terminal of the integrator may receive the initialization voltage VINT. The integrator may include an integration capacitor CF connected to a non-inverting terminal of the integrator. The sensing driver 600 may further include a first switch SW1 which selectively connects the integrator to the sensing line SL. The sensing driver 600 may further include a second switch SW2 which selectively applies the initialization voltage VINT to the sensing line SL.

The emission control transistor T5 may include a first electrode receiving a first power voltage ELVDD, a control electrode receiving the emission signal EM and the second electrode connected to the first electrode (e.g., the first node N1) of the driving transistor T1. When the emission control transistor T5 is turned-on in response to the emission signal EM, the light emitting element EE may emit light based on the driving current.

The light emitting element EE may include an anode connected to the third node N3 and a cathode receiving a second power voltage ELVSS. In one embodiment, the first power voltage ELVDD may be greater than the second power voltage ELVSS.

The light emitting element EE may emit light based on the driving current. In an embodiment, the light emitting element EE may be an organic light emitting diode OLED, but is not limited thereto. In an embodiment, the light emitting element EE may be any suitable light emitting element. For example, the light emitting element EE may be a nano light emitting diode NED, a quantum dot QD light emitting diode, a micro light emitting diode, an inorganic light emitting diode, or any other suitable light emitting element.

The first capacitor CST (e.g., a storage capacitor) may include a first electrode connected to the control electrode (e.g., the second node N2) of the driving transistor T1 and a second electrode connected to the second electrode (e.g., the third node N3) of the driving transistor T1. The first capacitor CST may store the data voltage VDATA.

The second capacitor CHOLD may include a first electrode coupled to receive the first power voltage ELVDD and a second electrode connected to the second electrode (e.g., the third node N3) of the driving transistor T1. The second capacitor CHOLD may be referred to as a holding capacitor, which operates to maintain a voltage of the second electrode (e.g., the third node N3) of the driving transistor T1.

When the sensing operation according to the present embodiment is performed, the voltage of the third node N3 may be set to the initialization voltage VINT. Accordingly, when the sensing operation is performed, the light emitting element EE may not emit light. Accordingly, the display apparatus according to the present inventive concept may perform a non-emitting sensing operation to be used in deterioration compensation of the display panel.

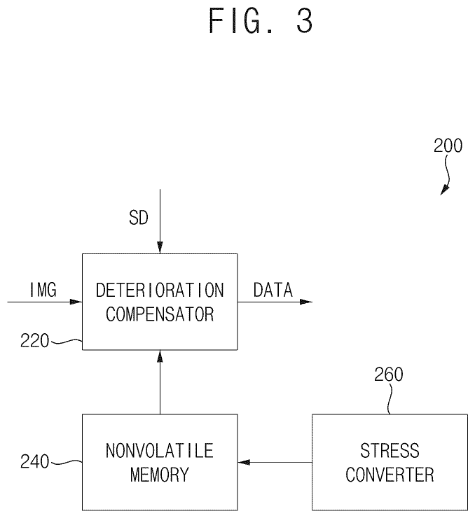

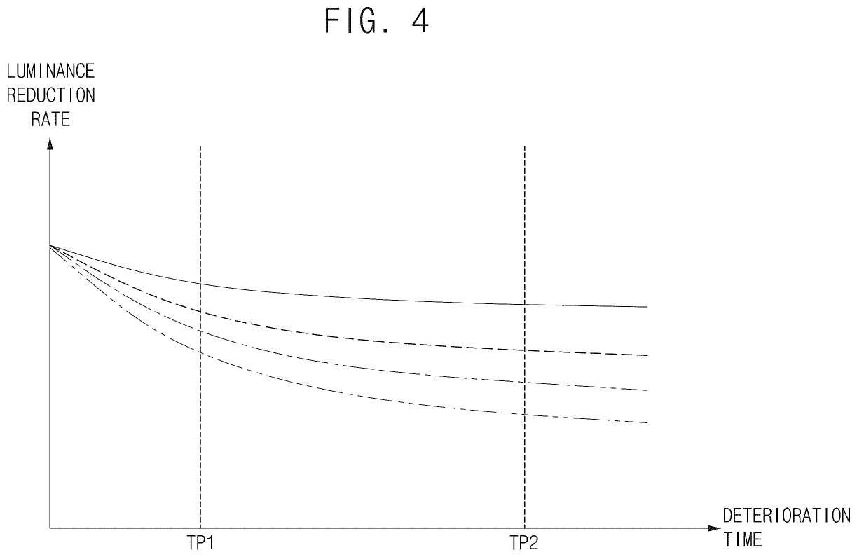

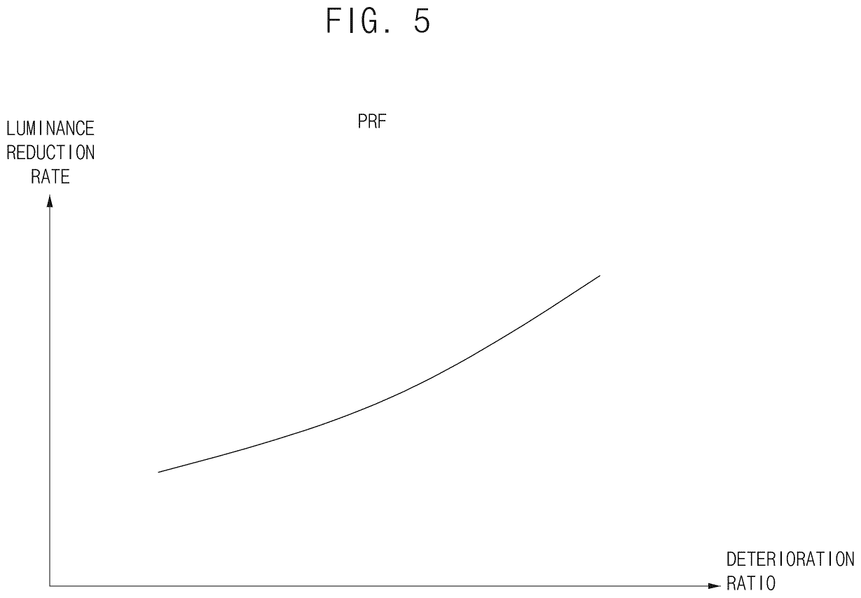

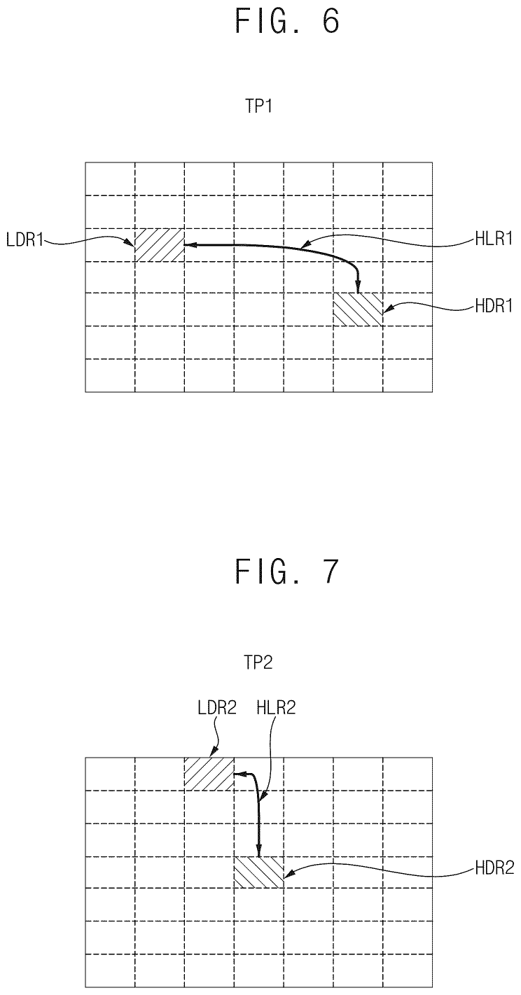

FIG. 3 is a block diagram illustrating a driving controller 200 of FIG. 1 according to an embodiment. FIG. 4 is a graph illustrating an example of a luminance reduction rate according to a deterioration time stored in a driving controller 200 of FIG. 1. FIG. 5 is an example of a graph illustrating a prediction function PRF according to which the driving controller 200 of FIG. 1 generates. FIG. 6 is a diagram illustrating an example of a high deterioration region HDR1 and a low deterioration region LDR1 of display panel 100 of FIG. 1 in a first time TP1. FIG. 7 is a diagram illustrating an example of a high deterioration region HDR2 and a low deterioration region LDR2 of display panel 100 of FIG. 1 in a second time TP2.

Referring to FIG. 1 to FIG. 7, the driving controller 200 includes the deterioration compensator 220, a nonvolatile memory 240, and stress converter 260. The deterioration compensator 220 may generate the data signal DATA compensating the deterioration of the display panel 100. For example, when a specific region of the display panel 100 displays a brighter image than a desired image due to the deterioration, the deterioration compensator 220 may adjust the data signal DATA to be dark (e.g., to be a predetermined grayscale value) so that the specific region may display the desired image. The predetermined grayscale value may be, for example, a black color.

The deterioration compensator 220 may receive the sensing data SD of the high deterioration region HDR and the sensing data SD of the low deterioration region LDR. The sensing data SD may include data of the sensing current output from driving transistors of pixels in the high deterioration region HDR and the low deterioration region LDR.

The nonvolatile memory 240 may store deterioration time and a luminance reduction rate of each pixel PX in the high deterioration region HDR and the low deterioration region LDR according to the deterioration time. The nonvolatile memory 240 may accumulate and store the deterioration time and the luminance reduction rate of the pixel PX according to the deterioration time. Accordingly, the nonvolatile memory 240 may store a function representing the luminance reduction rate according to the deterioration time.

Additionally, the nonvolatile memory 240 may store data of the high deterioration region HDR (which is the region where the luminance reduction rate is elevated or maximum) and data of the low deterioration region LDR (which is the region where the luminance reduction rate is reduced or at a minimum). For example, the nonvolatile memory 240 may be a flash memory. In an embodiment, the nonvolatile memory 240 may not be included in the driving controller 200 and may be integrated in the display panel driver.

The stress converter 260 may output the luminance reduction rate of a pixel PX according to the deterioration time.

In the present embodiment, the deterioration compensator 220 may calculate a deterioration ratio HLR, which is a ratio between a sensing current of the pixel in the high deterioration region HDR and a sensing current of the pixel in the low deterioration region LDR. The deterioration compensator 220 may store the deterioration ratio HLR. For example, when the display panel 100 is deteriorated during a first time TP1, the high deterioration region HDR corresponding to the first time TP1 and the low deterioration region LDR corresponding to the first time TP1 may be calculated. The stress converter 260 may output the luminance reduction rate corresponding to the first time TP1 to the nonvolatile memory 240. The nonvolatile memory 240 may output the luminance reduction rate corresponding to the first time TP1 to the deterioration compensator 220.

The sensing driver 600 may perform the sensing operation for a pixel in a first high deterioration region HDR1 corresponding to the first time TP1 and a pixel in a first low deterioration region LDR1 corresponding to the first time TP1. The sensing driver 600 may output the sensing data SD of the first high deterioration region HDR1 and the sensing data SD of the first low deterioration region LDR1 to the deterioration compensator 220.

The deterioration compensator 220 may receive the sensing data SD of at least one pixel in the first high deterioration region HDR1 and the sensing data SD of at least one pixel in the first low deterioration region LDR1 and may calculate the deterioration ratio HLR corresponding to the first time TP1. For example, the deterioration ratio HLR corresponding to the first time TP1 may be a first deterioration ratio HLR1. The deterioration compensator 220 may store the first deterioration ratio HLR1 and the luminance reduction rate of the first high deterioration region HDR1 corresponding to the first time TP1. In the present embodiment, the luminance reduction rate corresponding to the first time TP1 may correspond to the first deterioration ratio HLR1. The driving controller 200 may store the luminance reduction rate of the first high deterioration region HDR1 corresponding to the first deterioration ratio HLR1.

For example, when the display panel 100 is deteriorated during a second time TP2 different from (e.g., later than) the first time TP1, the high deterioration region HDR and the low deterioration region LDR may change. For example, the high deterioration region HDR corresponding to the second time TP2 may be a second high deterioration region HDR2 different from the first high deterioration region HDR1 corresponding to the first time TP1. The low deterioration region LDR corresponding to the second time TP2 may be a second low deterioration region LDR2 different from the first low deterioration region LDR1 corresponding to the first time TP1. The high deterioration region HDR and the low deterioration region LDR may change, so that the deterioration ratio HLR may change. The deterioration ratio HLR corresponding to the second time TP2 may be a second deterioration ratio HLR2. The stress converter 260 may output the luminance reduction rate corresponding to the second time TP2 to the nonvolatile memory 240. The nonvolatile memory 240 may output the luminance reduction rate corresponding to the second time TP2 to the deterioration compensator 220. In the present embodiment, the luminance reduction rate corresponding to the second time TP2 may correspond to the second deterioration ratio HLR2. The driving controller 200 may store the luminance reduction rate of the second high deterioration region HDR2 corresponding to the second deterioration ratio HLR2.

In the present embodiment, the deterioration compensator 220 may accumulate and store the deterioration ratio HLR and the luminance reduction rate corresponding to the deterioration ratio HLR. Accordingly, as shown in FIG. 5, the deterioration compensator 220 may generate the prediction function PRF based on the deterioration ratio HLR (accumulated and stored) and the luminance reduction rate corresponding to the deterioration ratio HLR accumulated and stored. The deterioration compensator 220 may output the data signal DATA based on the prediction function PRF. In an embodiment, the prediction function PRF may be based on, for example, a linear function model or the prediction function PRF may correspond to a curved line.

In a display apparatus which does not have a deterioration compensator, when a non-emitting sensing operation is performed, the display quality of a display panel may be reduced because a change of sensing current corresponding to predetermined (e.g., black) color is not considered. On the other hand, the display apparatus according to the present inventive concept may output the data signal DATA by taking into consideration the deterioration ratio HLR. Accordingly, the display quality of the display apparatus according to the present inventive concept may be improved.

In an embodiment, the deterioration ratio HLR may be a ratio between a value obtained by dividing the sensing current of at least one pixel in the high deterioration region HDR after a deterioration time by the sensing current of at least one pixel in the low deterioration region LDR after the deterioration time, and a value obtained by dividing the sensing current of the at least one pixel in the high deterioration region HDR in an initial time by the sensing current of the at least one pixel in the low deterioration region LDR in the initial time. For example, the initial time may refer to a time after the production stage of the display apparatus before the sensing current of the pixels PX change due to deterioration.

Accordingly, in the display apparatus according to the present inventive concept, the deterioration rate HLR may be calculated by reflecting an initial distribution of the sensing current. Accordingly, the display quality of the display apparatus according to the present inventive concept may be further improved.

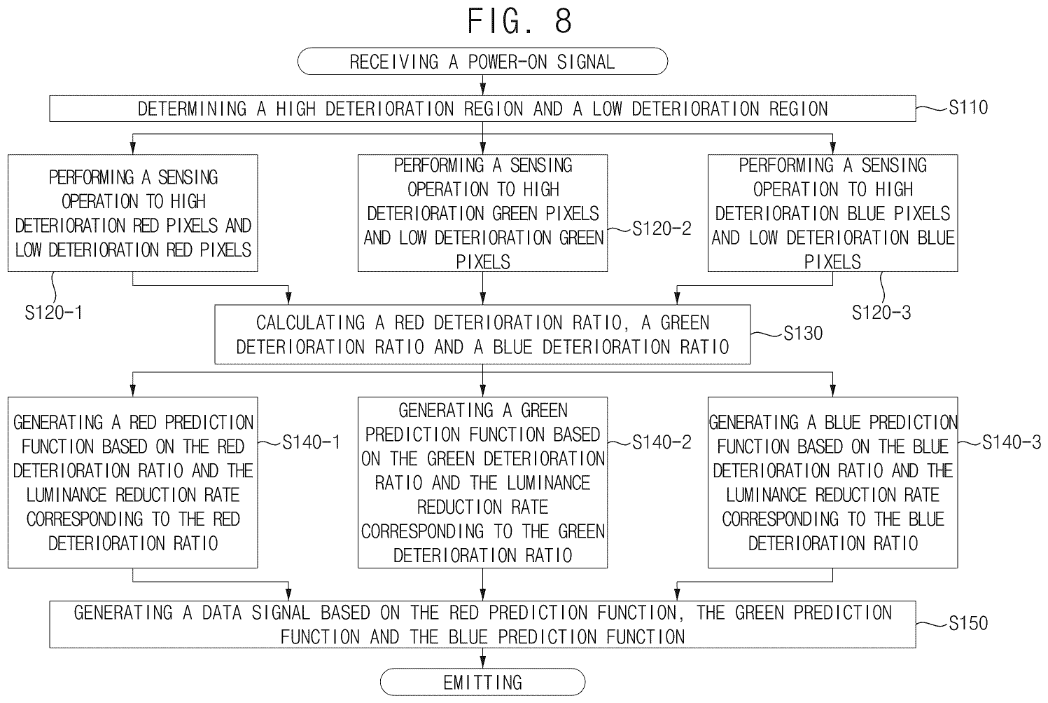

FIG. 8 is a flowchart illustrating an operation of a driving controller and a sensing driver of FIG. 1 according to an embodiment.

Referring to FIG. 1, FIG. 3, FIG. 5 and FIG. 8, in the present embodiment, the high deterioration region HDR may include one or more high deterioration red pixels, one or more high deterioration green pixels, and one or more high deterioration blue pixels. The low deterioration region LDR may include one or more low deterioration red pixels, one or more low deterioration green pixels and one or more low deterioration blue pixels. The driving controller 200 may determine the high deterioration region HDR and the low deterioration region LDR (S110). The sensing driver 600 may perform the sensing operation to one or more of the high deterioration red pixels and one or more of the low deterioration red pixels (S120-1). The sensing driver 600 may perform the sensing operation to the one or more high deterioration green pixels and the one or more low deterioration green pixels (S120-2). The sensing driver 600 may perform the sensing operation to the one or more high deterioration blue pixels and the one or more low deterioration blue pixels (S120-3). In an embodiment, the sensing operation may be performed in response to the power-on signal POS received by the driving controller 200. In an embodiment, when the sensing operation is performed, the stress converter 260 may be turned-off.

In the present embodiment, the deterioration ratio HLR may include a red deterioration ratio which is a ratio between the sensing current of the one or more high deterioration red pixels and the sensing current of the one or more low deterioration red pixels, a green deterioration ratio which is a ratio between the sensing current of the one or more high deterioration green pixels and the sensing current of the one or more low deterioration green pixels, and a blue deterioration ratio which is a ratio between the sensing current of the one or more high deterioration blue pixels and the sensing current of the one or more low deterioration blue pixels. The driving controller 200 may calculate the red deterioration ratio, the green deterioration ratio, and the blue deterioration ratio (S130).

Additionally, the driving controller 200 may accumulate and store the red deterioration ratio and the luminance reduction rate corresponding to the red deterioration ratio. The driving controller 200 may generate a red prediction function based on the red deterioration ratio and the luminance reduction rate corresponding to the red deterioration ratio (S140-1). The driving controller 200 may accumulate and store the green deterioration ratio and the luminance reduction rate corresponding to the green deterioration ratio. The driving controller 200 may generate a green prediction function based on the green deterioration ratio and the luminance reduction rate corresponding to the green deterioration ratio (S140-2). The driving controller 200 may accumulate and store the blue deterioration ratio and the luminance reduction rate corresponding to the blue deterioration ratio. The driving controller 200 may generate a blue prediction function based on the blue deterioration ratio and the luminance reduction rate corresponding to the blue deterioration ratio (S140-3).

In the present embodiment, the driving controller 200 may generate the data signal DATA based on the red prediction function, the green prediction function, and the blue prediction function (S150).

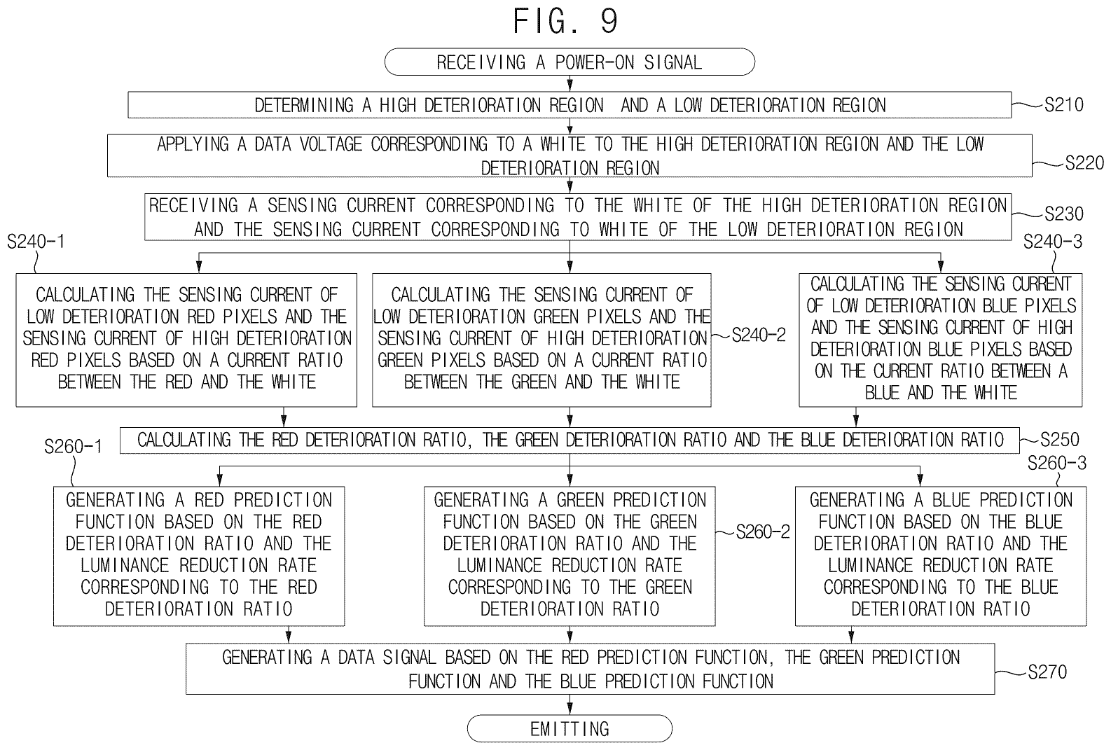

FIG. 9 is a flowchart illustrating an operation of the driving controller and the sensing driver of FIG. 1 according to an embodiment.

Referring to FIG. 1, FIG. 3, FIG. 5 and FIG. 9, in the present embodiment, the driving controller 200 may determine the high deterioration region HDR and the low deterioration region LDR (S210). The high deterioration region HDR and the low deterioration region LDR may correspond to different pixels PX in the display panel. The data driver 500 may apply the data voltage VDATA corresponding to a predetermined (e.g., white) color to the high deterioration region HDR and the low deterioration region LDR (S220). The sensing driver 600 may receive the sensing current corresponding to the white color of the high deterioration region HDR and the sensing current corresponding to the white color of the low deterioration region LDR.

The driving controller 200 may receive the sensing current corresponding to the white color of the high deterioration region HDR and the sensing current corresponding to the white color of the low deterioration region LDR (S230). The driving controller 200 may calculate the sensing current of the one or more low deterioration red pixels and the sensing current of the one or more high deterioration red pixels based on the current ratio between the red and the white colors (S240-1). The driving controller 200 may calculate the sensing current of the one or more low deterioration green pixels and the sensing current of the one or more high deterioration green pixels based on the current ratio between the green and the white colors (S240-2). The driving controller 200 may calculate the sensing current of the one or more low deterioration blue pixels and the sensing current of the one or more high deterioration blue pixels based on the current ratio between the blue and the white colors (S240-3).

The driving controller 200 may calculate the red deterioration ratio, which is the ratio between the sensing current of the one or more high deterioration red pixels and the sensing current of the one or more low deterioration red pixels. The driving controller 200 may calculate the green deterioration ratio, which is the ratio between the sensing current of the one or more high deterioration green pixels and the sensing current of the one or more low deterioration green pixels. The driving controller 200 may calculate the blue deterioration ratio, which is the ratio between the sensing current of the one or more high deterioration blue pixels and the sensing current of the one or more low deterioration blue pixels.

In the present embodiment, the driving controller 200 may calculate the red deterioration ratio, the green deterioration ratio, and the blue deterioration ratio (S250). The driving controller 200 may generate a red prediction function based on the red deterioration ratio and the luminance reduction rate corresponding to the red deterioration ratio (S260-1). The driving controller 200 may generate a green prediction function based on the green deterioration ratio and the luminance reduction rate corresponding to the green deterioration ratio (S260-2). The driving controller 200 may generate a blue prediction function based on the blue deterioration ratio and the luminance reduction rate corresponding to the blue deterioration ratio (S260-3). The driving controller 200 may generate the data signal DATA based on the red prediction function, the green prediction function and the blue prediction function (S270).

Accordingly, in the present embodiment, the data voltage VDATA corresponding to the white color is generated, so that the time which the sensing operation is performed may be reduced.

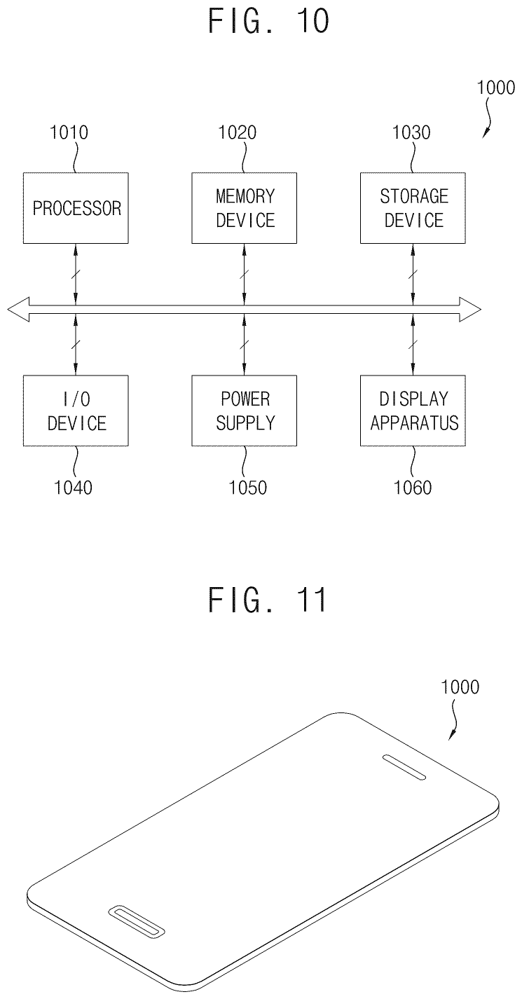

FIG. 10 is a block diagram illustrating an electronic apparatus 1000 according to an embodiment of the present inventive concept. FIG. 11 is a view illustrating an example in which the electronic apparatus 1000 of FIG. 10 is implemented as a smart phone.

Referring to FIG. 10 and FIG. 11, the electronic apparatus 1000 may include a processor 1010, a memory device 1020, a storage device 1030, an input/output (I/O) device 1040, a power supply 1050 and a display apparatus 1060. Here, the display apparatus 1060 may be the display apparatus of FIG. 1. In addition, the electronic apparatus 1000 may further include a plurality of ports for communicating with a video card, a sound card, a memory card, a universal serial bus (USB) device, and/or other electronic apparatuses.

According to an embodiment, as shown in FIG. 11, the electronic apparatus 1000 may be implemented as a smart phone. However, the electronic apparatus 1000 is not limited thereto. For example, the electronic apparatus 1000 may be implemented as a cellular phone, a video phone, a smart pad, a smart watch, a tablet PC, a car navigation system, a computer monitor, a laptop, a head mounted display (HMD) device and the like.

The processor 1010 may perform various computing functions or various tasks. The processor 1010 may be a micro-processor, a central processing unit (CPU), an application processor (AP) and the like. The processor 1010 may be coupled to other components via an address bus, a control bus, a data bus, etc. Further, the processor 1010 may be coupled to an extended bus such as a peripheral component interconnection (PCI) bus. The processor 1010 may output the input image data IMG and the input control signal CONT to the driving controller 200 of FIG. 1.

The memory device 1020 may store data for operations of the electronic apparatus 1000. For example, the memory device 1020 may include at least one non-volatile memory device such as an erasable programmable read-only memory (EPROM) device, an electrically erasable programmable read-only memory (EEPROM) device, a flash memory device, a phase change random access memory (PRAM) device, a resistance random access memory (RRAM) device, a nano floating gate memory (NFGM) device, a polymer random access memory (PoRAM) device, a magnetic random access memory (MRAM) device, a ferroelectric random access memory (FRAM) device and the like and/or at least one volatile memory device such as a dynamic random access memory (DRAM) device, a static random access memory (SRAM) device, a mobile DRAM device and the like.

The storage device 1030 may include a solid state drive (SSD) device, a hard disk drive (HDD) device, a CD-ROM device and the like. The I/O device 1040 may include an input device such as a keyboard, a keypad, a mouse device, a touch-pad, a touch-screen and the like and an output device such as a printer, a speaker and the like. In some embodiments, the display apparatus 1060 may be included in the I/O device 1040. The power supply 1050 may provide power for performing operations of the electronic apparatus 1000. The display apparatus 1060 may be coupled to other components via the buses or other communication links.

According to the display apparatus and the method of compensating a deterioration of the display panel described above, the display quality of the display panel may be improved by improving an accuracy of deterioration compensation.

The methods, processes, and/or operations described herein may be performed by code or instructions to be executed by a computer, processor, controller, or other signal processing device. The computer, processor, controller, or other signal processing device may be those described herein or one in addition to the elements described herein. Because the algorithms that form the basis of the methods (or operations of the computer, processor, controller, or other signal processing device) are described in detail, the code or instructions for implementing the operations of the method embodiments may transform the computer, processor, controller, or other signal processing device into a special-purpose processor for performing the methods herein.

Also, another embodiment may include a computer-readable medium, e.g., a non-transitory computer-readable medium, for storing the code or instructions described above. The computer-readable medium may be a volatile or non-volatile memory or other storage device, which may be removably or fixedly coupled to the computer, processor, controller, or other signal processing device which is to execute the code or instructions for performing the method embodiments or operations of the apparatus embodiments herein.

In one embodiment, a non-transitory computer-readable medium may store instructions which cause one or more processors to calculate a deterioration ratio between a sensing current of at least one pixel in a high deterioration region where the luminance reduction rate is at a first level and a sensing current of at least one pixel in a low deterioration region where the luminance reduction rate is at a second level lower than the first level; obtain a luminance reduction rate corresponding to the deterioration ratio; generate a prediction function based on the deterioration ratio and the luminance reduction rate; and generate a data signal based on the luminance reduction rate.

The controllers, processors, compensators, drivers, converters, generators and other signal generating and signal processing features of the embodiments disclosed herein may be implemented, for example, in non-transitory logic that may include hardware, software, or both. When implemented at least partially in hardware, the controllers, processors, compensators, drivers, converters, generators and other signal generating and signal processing features may be, for example, any one of a variety of integrated circuits including but not limited to an application-specific integrated circuit, a field-programmable gate array, a combination of logic gates, a system-on-chip, a microprocessor, or another type of processing or control circuit. In some embodiments, these features may be implemented by a neural network, machine-learning logic, or other form of artificial intelligence.

When implemented in at least partially in software, the controllers, processors, compensators, drivers, converters, generators and other signal generating and signal processing features may include, for example, a memory or other storage device for storing code or instructions to be executed, for example, by a computer, processor, microprocessor, controller, or other signal processing device. The computer, processor, microprocessor, controller, or other signal processing device may be those described herein or one in addition to the elements described herein. Because the algorithms that form the basis of the methods (or operations of the computer, processor, microprocessor, controller, or other signal processing device) are described in detail, the code or instructions for implementing the operations of the method embodiments may transform the computer, processor, controller, or other signal processing device into a special-purpose processor for performing the methods described herein.

The foregoing is illustrative of the present inventive concept and is not to be construed as limiting thereof. Although a few embodiments of the present inventive concept have been described, those skilled in the art will readily appreciate that many modifications are possible in the embodiments without materially departing from the novel teachings and advantages of the present inventive concept. Accordingly, all such modifications are intended to be included within the scope of the present inventive concept as defined in the claims. In the claims, means-plus-function clauses are intended to cover the structures described herein as performing the recited function and not only structural equivalents but also equivalent structures. Therefore, it is to be understood that the foregoing is illustrative of the present inventive concept and is not to be construed as limited to the specific embodiments disclosed and that modifications to the disclosed embodiments, as well as other embodiments, are intended to be included within the scope of the appended claims. The present inventive concept is defined by the following claims, with equivalents of the claims to be included therein. The embodiments may be combined to form additional embodiments.

What is claimed is:

1. A display apparatus comprising:
a display panel including a low deterioration region and a high deterioration region;
a driving controller configured to generate a data signal based on input image data; and
a data driver configured to convert the data signal to a data voltage and configured to output the data voltage to the display panel;
wherein the driving controller includes a deterioration compensator, and
wherein the deterioration compensator is configured to generate the data signal based on a deterioration ratio between a sensing current of one or more pixels in the low deterioration region and a sensing current of one or more pixels in the high deterioration region.

2. The display apparatus of claim 1, wherein:
the driving controller includes a stress convertor configured to output to the deterioration compensator a luminance reduction rate according to a deterioration time,
the low deterioration region is where the luminance reduction rate is at a first level, and
the high deterioration region is where the luminance reduction rate is at a second level greater than the first level.

3. The display apparatus of claim 2, wherein the deterioration compensator is configured to output the data signal based on the luminance reduction rate corresponding to the deterioration ratio.

4. The display apparatus of claim 2, wherein the driving controller includes a nonvolatile memory configured to store the luminance reduction rate according to the deterioration time.

5. The display apparatus of claim 2, wherein the driving controller is configured to store the deterioration ratio and the luminance reduction rate corresponding to the deterioration ratio.

6. The display apparatus of claim 5, wherein:
the deterioration compensator is configured to generate a prediction function based on the stored deterioration ratio and the stored luminance reduction rate corresponding to the deterioration ratio, and
the deterioration compensator is configured to output the data signal based on the prediction function.

7. The display apparatus of claim 6, wherein the prediction function is a linear function.

8. The display apparatus of claim 2, wherein the low deterioration region and the high deterioration region change according to the deterioration time.

9. The display apparatus of claim 1, wherein the deterioration ratio is between a value obtained by dividing the sensing current of the one or more pixels in the high deterioration region after a deterioration time by the sensing current of the one or more pixels in the low deterioration region after the deterioration time and a value obtained by dividing the sensing current of the one or more pixels in the high deterioration region in an initial time by the sensing current of the one or more pixels in the low deterioration region in the initial time.

10. The display apparatus of claim 1, further comprising:
a sensing driver,
wherein the high deterioration region includes one or more high deterioration red pixels, one or more high deterioration green pixels, and one or more high deterioration blue pixels,
wherein the low deterioration region includes low deterioration one or more red pixels, one or more low deterioration green pixels, and one or more low deterioration blue pixels,
wherein the sensing driver is configured to perform a sensing operation where the sensing current of the low deterioration region and the sensing current of the high deterioration region are received, and
wherein the sensing operation is performed for the one or more high deterioration red pixels, the one or more high deterioration green pixels, the one or more high deterioration blue pixels, the one or more low deterioration red pixels, the one or more low deterioration green pixels, and the one or more low deterioration blue pixels.

11. The display apparatus of claim 10, wherein the deterioration ratio includes:
a red deterioration ratio between the sensing current of the one or more high deterioration red pixels and the sensing current of the one or more low deterioration red pixels;
a green deterioration ratio between the sensing current of the one or more high deterioration green pixels and the sensing current of the one or more low deterioration green pixels; and
a blue deterioration ratio between the sensing current of the one or more high deterioration blue pixels and the sensing current of the one or more low deterioration blue pixels.

12. The display apparatus of claim 11, wherein:
the driving controller includes a stress converter configured to output a luminance reduction rate according to a deterioration time to the deterioration compensator,
the driving controller is configured to store the red deterioration ratio and the luminance reduction rate corresponding to the red deterioration ratio and to generate a red prediction function based on the red deterioration ratio and the luminance reduction rate corresponding to the red deterioration ratio,
the driving controller is configured to store the green deterioration ratio and the luminance reduction rate corresponding to the green deterioration ratio and to generate a green prediction function based on the green deterioration ratio and the luminance reduction rate corresponding to the green deterioration ratio,
the driving controller is configured to store the blue deterioration ratio and the luminance reduction rate corresponding to the blue deterioration ratio and to generate a blue prediction function based on the blue deterioration ratio and the luminance reduction rate corresponding to the blue deterioration ratio, and
the driving controller is configured to generate the data signal based on the red prediction function, the green prediction function and the blue prediction function.

13. The display apparatus of claim 10, wherein the sensing operation is performed in response to a power-on signal.

14. The display apparatus of claim 1, further comprising:
a sensing driver configured to perform a sensing operation which includes receiving the sensing current of the one or more pixels in the low deterioration region and the sensing current of the one or more pixels in the high deterioration region,
wherein the data driver is configured to apply the data voltage corresponding to white color to the high deterioration region and the low deterioration region, and
wherein the driving controller is configured to calculate a red deterioration ratio between the sensing current of one or more high deterioration red pixels and the sensing current of one or more low deterioration red pixels, a green deterioration ratio between the sensing current of one or more high deterioration green pixels and the sensing current of one or more low deterioration green pixels and a blue deterioration ratio between the sensing current of one or more high deterioration blue pixels and the sensing current of one or more low deterioration blue pixels based on the sensing current corresponding to the white color of the high deterioration region and the sensing current corresponding to the white color of the low deterioration region.

15. The display apparatus of claim 14, wherein:
the driving controller includes a stress converter configured to output a luminance reduction rate of a pixel according to a deterioration time to the deterioration compensator,
the driving controller is configured to store the red deterioration ratio and the luminance reduction rate corresponding to the red deterioration ratio and to generate a red prediction function based on the red deterioration ratio and the luminance reduction rate corresponding to the red deterioration ratio,
the driving controller is configured to store the green deterioration ratio and the luminance reduction rate corresponding to the green deterioration ratio and to generate a green prediction function based on the green deterioration ratio and the luminance reduction rate corresponding to the green deterioration ratio,
the driving controller is configured to store the blue deterioration ratio and the luminance reduction rate corresponding to the blue deterioration ratio and to generate a blue prediction function based on the blue deterioration ratio and the luminance reduction rate corresponding to the blue deterioration ratio, and
the driving controller is configured to generate the data signal based on the red prediction function, the green prediction function and the blue prediction function.

16. The display apparatus of claim 1, wherein
each of the pixels in the low deterioration region and the high deterioration region include:
a driving transistor configured to output a driving current;
a light emitting element configured to emit a light based on the driving current;
an initialization transistor configured to apply an initialization voltage to a second electrode of the driving transistor;
a scan transistor configured to apply the data voltage to a control electrode of the driving transistor;
a compensation transistor configured to apply a reference voltage to the control electrode of the driving transistor;
an emission control transistor configured to control a generation of the driving current;
a first capacitor including a first electrode connected to the control electrode of the driving transistor and a second electrode connected to the second electrode of the driving transistor; and
a second capacitor including a first electrode configured to receive a first power voltage and a second electrode connected to the second electrode of the driving transistor.

17. A method of compensating deterioration of a display panel, the method comprising:
storing a luminance reduction rate of a pixel according to a deterioration time;
calculating a deterioration ratio between a sensing current of one or more pixels in a high deterioration region where the luminance reduction rate is at a first level and a sensing current of one or more pixels in a low deterioration region where the luminance reduction rate is at a second level lower than the first level;
storing the deterioration ratio and the luminance reduction rate corresponding to the deterioration ratio; and
generating a data signal based on the luminance reduction rate.

18. The method of claim 17, further comprising:
generating a prediction function based on the stored deterioration ratio and the stored luminance reduction rate corresponding to the deterioration ratio after storing the luminance reduction rate corresponding to the deterioration ratio, wherein the data signal is generated based on the prediction function.

19. The method of claim 17, wherein the low deterioration region and the high deterioration region change according to the deterioration time.

20. The method of claim 17, wherein the deterioration ratio is between a value obtained by dividing the sensing current of the one or more pixels in the high deterioration region after a deterioration time by the sensing current of the one or more pixels in the low deterioration region after the deterioration time and a value obtained by dividing the sensing current of the one or more pixels in the high deterioration region in an initial time by the sensing current of the one or more pixels in the low deterioration region in the initial time.

21. A method for compensating a display apparatus, comprising:
receiving a first sensing current of a pixel in a high deterioration region of a display panel;
receiving a second sensing current of a pixel in a low deterioration region of the display panel;
calculating a deterioration ratio based on the first sensing current and the second sensing current;
determining a luminance reduction rate which corresponds to the deterioration ratio;
generating a prediction function based on the deterioration ratio and the luminance reduction rate; and
generating a data signal based on the prediction function.

22. The method of claim 21, wherein:
the pixel in the high deterioration region is configured to emit light of a first level, and
the pixel in the low deterioration region is configured to emit light of a second level less than the first level.

23. The method of claim 21, wherein the low deterioration region and the high deterioration region change over time.
